(19) United States
(12) Patent Application Publication
(10) Pub. No.: US 2025/0215192 A1
(43) Pub. Date: Jul. 3, 2025

(54) BORON NITRIDE POWDER, RESIN COMPOSITION, AND METHOD FOR PRODUCING BORON NITRIDE POWDER

(71) Applicant: Denka Company Limited, Tokyo (JP)

(72) Inventors: Go TAKEDA, Chuo Tokyo (JP); Rei TANAKA, Chuo Tokyo (JP)

(21) Appl. No.: 18/850,543

(22) PCT Filed: Mar. 28, 2023
(86) PCT No.: PCT/JP2023/012545

§ 371 Date: Sep. 24, 2024

(30) Foreign Application Priority Data
Mar. 30, 2022 (JP) 2022-055202

(51) Int. Cl. C08K 3/38; C01B 21/064

(52) U.S. Cl. CPC C08K 3/38; C01B 21/0645; C01B 21/0648; C01P 2004/50; C01P 2004/61; C01P 2006/12; C01P 2006/82; C01P 2006/90; C08K 2003/385; C08K 2201/005; C08K 2201/006

(57) ABSTRACT

A boron nitride powder that includes agglomerated particles formed by agglomeration of primary particles of boron nitride, where a graphitization index is 2.0 or less, a boron oxide content is 0.1% by mass or less, and a boron oxide content after a heat cycle test is 0.2% by mass or less.

### TECHNICAL FIELD

The present disclosure relates to a boron nitride powder, a resin composition, and a method for producing a boron nitride powder.

### BACKGROUND ART

In electronic components such as power devices, transistors, thyristors, and CPUs, there is an issue that heat generated during use needs to be efficiently dissipated. In response to this issue, approaches, such as increasing the thermal conductivity of the insulating layer of the printed wiring board on which electronic components are mounted, and attaching electronic components or a printed wiring board to a heat sink by interposing a thermal interface material having electrical insulating properties, have been employed in the related art. For a material (thermally conductive insulating material) that requires such thermal conductivity and insulating properties, a ceramic powder having a high thermal conductivity is used.

As the ceramic powder, a boron nitride powder, which has properties such as high thermal conductivity, high insulating properties, and low dielectric constant, has attracted attention. On the other hand, since boron nitride particles (particularly, hexagonal boron nitride particles) have large anisotropy in thermal conductivity, it has been studied to suppress the anisotropy in thermal conductivity due to the orientation of the primary particles by agglomerating primary particles of boron nitride to form boron nitride agglomerated particles (for example, Patent Literature 1).

### CITATION LIST

### Patent Literature

[Patent Literature 1] Japanese Unexamined Patent Publication No. 2016-135731

### SUMMARY OF INVENTION

### Technical Problem

However, in such a situation in which an electronic component is used for a long period of time in an environment with a high temperature and/or a large humidity load, the insulating properties of the thermally conductive insulating material incorporated in the electronic component (for example, a thermally conductive insulating material containing a boron nitride powder as a filler) gradually deteriorate, and thus dielectric breakdown or the like may occur. Therefore, there is a demand for a thermally conductive insulating material that can maintain excellent insulating properties over a long period of time, that is, a thermally conductive insulating material that has excellent long-term insulating properties.

One aspect of the present disclosure aims to provide a boron nitride powder that improves the long-term insulating properties of a thermally conductive insulating material. In addition, another aspect of the present disclosure aims to provide a method for producing the boron nitride powder. In addition, still another aspect of the present disclosure aims to provide a resin composition using the boron nitride powder.

### Solution to Problem

From the studies carried out by the inventors of the present invention, it was revealed that the boron oxide (B₂O₃) content in the boron nitride powder affects the insulating properties of the thermally conductive insulating material and that the boron oxide content in the boron nitride powder increases in a use environment for the above-described electronic component. Based on these findings, the inventors of the present invention have completed the present invention.

The present disclosure provides at least the following [1] to [11].
[1] A boron nitride powder comprising:
   agglomerated particles formed by agglomeration of primary particles of boron nitride,
   wherein a graphitization index is 2.0 or less,
   a boron oxide content is 0.1% by mass or less, and
   a boron oxide content after a heat cycle test of a total of 1,000 cycles is 0.2% by mass or less, where one cycle is defined by the following operation (i),
   (i) 10 g of the boron nitride powder is heated from 0° C. to 50° C. at a temperature rising rate of 3.0° C./min under a humidity of 80% RH, and then held for 30 minutes and cooled from 50° C. to 0° C. at a cooling rate of 1.5° C./min, followed by being held for 30 minutes.
[2] The boron nitride powder according to [1], wherein the agglomerated particles have a crushing strength of 4 MPa or more.
[3] The boron nitride powder according to [1] or [2], wherein the boron nitride powder has a moisture amount of 300 ppm by mass or less.
[4] The boron nitride powder according to any one of [1] to [3], wherein the boron nitride powder has a specific surface area of 5.0 m²/g or less.
[5] The boron nitride powder according to any one of [1] to [4], wherein the boron nitride powder has an average particle diameter of 10 to 90 μm.
[6] The boron nitride powder according to any one of [1] to [5], wherein the boron nitride powder has an orientation index of 15 or less.
[7] A resin composition comprising:
   a resin; and
   the boron nitride powder according to any one of [1] to [6].
[8] A method for producing a boron nitride powder, the method comprising:
   a decarbonization-crystallization step of firing and cooling a raw material mixture containing a boron carbonitride powder and a boron source to generate primary particles of boron nitride and obtaining a powder containing agglomerated particles formed by agglomeration of primary particles,
   wherein in the decarbonization-crystallization step, the raw material mixture is fired and cooled in a closed space having a nitrogen gas concentration of 99.90% by volume or more and a leakage amount of 270×10⁻⁴ Pa·m³/sec or less.
[9] The method for producing a boron nitride powder according to [8], further comprising a step of pulverizing the agglomerated particles in the powder by frictional shearing, after the decarbonization-crystallization step.
[10] The method for producing a boron nitride powder according to [8] or [9], further comprising a step of washing the powder or a pulverized product thereof, after the decarbonization-crystallization step.
[11] The method for producing a boron nitride powder according to any one of [8] to [10], wherein in the decarbonization-crystallization step, the raw material mixture is fired by being heated from a temperature of 1,000° C. or lower to a holding temperature of 1,900° C. or higher at a temperature rising rate of 0.5 to 5.0° C./min and being held at the holding temperature for 2 hours or more.

### Advantageous Effects of Invention

According to the present disclosure, it is possible to provide a boron nitride powder that improves the long-term insulating properties of a thermally conductive insulating material and a method for producing the same, as well as a resin composition using the boron nitride powder.

### DESCRIPTION OF EMBODIMENTS

Unless otherwise specified, one kind of materials exemplified in the present specification may be used alone, or two or more kinds thereof may be used in combination. In a case where a plurality of substances corresponding to components are present in the composition, the content of each component in the composition means a total amount of the plurality of substances present in the composition, unless otherwise specified. In the present specification, a numerical value range expressed using “to” indicates a range including numerical values before and after “to” as a minimum value and a maximum value. With regard to a numerical value range described in the present specification, the upper limit value or lower limit value of the numerical value range may be replaced with the values disclosed in Examples. In addition, the upper limit value and the lower limit value, which are described individually, can be combined in any desired manner.

Hereinafter, embodiments of the present disclosure will be described. However, the following embodiments are merely examples for describing the present disclosure and thus are not intended to limit the present disclosure to the following contents.

### <Boron Nitride Powder>

A boron nitride powder according to one embodiment includes agglomerated particles formed by agglomeration of primary particles of boron nitride. The boron nitride powder may include primary particles (non-agglomerated particles) in addition to the agglomerated particles. The primary particles of boron nitride may be, for example, scaly hexagonal boron nitride particles.

The graphitization index of the boron nitride powder is 2.0 or less. Here, the graphitization index (G.I.) is an indicator that indicates the degree of crystallinity of graphite (see, for example, J. Thomas, et. al., J. Am. Chem. Soc. 84, 4619 (1962)). The graphitization index can also be used as an indicator of the crystallinity of boron nitride. It has a meaning in which the smaller the graphitization index, the higher the crystallinity of the boron nitride. As a result, a boron nitride powder containing boron nitride having a small graphitization index (for example, hexagonal boron nitride) tends to have excellent insulating properties due to having fewer impurities and concurrently tends to have excellent thermal conductivity due to having high crystallinity.

The graphitization index may be 1.9 or less, 1.8 or less, or 1.7 or less. A boron nitride powder having such a graphitization index tends to have more excellent insulating properties. The graphitization index may be 1.2 or more, 1.3 or more, 1.4 or more, or 1.5 or more, and it may be 1.2 to 2.0, 1.3 to 1.9, 1.4 to 1.8, or 1.5 to 1.7.

The graphitization index in the present specification is calculated based on a spectrum obtained by subjecting primary particles of boron nitride (for example, primary particles constituting the above-described agglomerated particles), which are contained in the boron nitride powder, to measurement according to a powder X-ray diffraction method. First, in the X-ray diffraction spectrum, values (in any unit) of areas, each of which is enclosed by the integrated intensity of one diffraction peak (that is, one diffraction peak) corresponding to the (100) plane, (101) plane, and (102) plane of the primary particles of boron nitride, and the baseline thereof, are calculated and denoted as $100, $101, and $102, respectively. The calculated area values are used to calculate the value of [(S100+S101)/S102] to determine the graphitization index. More specifically, they are determined according to the method described in Examples of the present specification.

The boron oxide (B₂O₃) content in the boron nitride powder is 0.1% by mass or less, and it may be 0.08% by mass or less, 0.06% by mass or less, 0.04% by mass or less, 0.02% by mass or less, or 0.01% by mass or less. The smaller the boron oxide content is, the higher insulating properties are obtained. The lower limit value of the boron oxide content may be 0% by mass, and it may be 0.001% by mass, 0.002% by mass, 0.005% by mass, or 0.01% by mass.

After a heat cycle test of a total of 1,000 cycles, where one cycle is defined by the following operation (1), the boron oxide (B₂O₃) content in the boron nitride powder is 0.2% by mass or less, and it may be 0.1% by mass or less, 0.05% by mass or less, 0.015% by mass or less, or 0.013% by mass or less.
(i) 10 g of the boron nitride powder is heated from 0° C. to 50° C. at a temperature rising rate of 3.0° C./min under a humidity of 80% RH, and then held for 30 minutes and cooled from 50° C. to 0° C. at a cooling rate of 1.5° C./min, followed by being held for 30 minutes.

The heat cycle test is a test that is carried out assuming that the boron nitride powder is used for a long period of time as a filler in a thermally conductive insulating material in a use environment for an electronic component. In the boron nitride powders in the related art, the boron oxide content increases after the heat cycle test, which causes the deterioration of insulating properties. On the contrary, in the above-described boron nitride powder, the boron oxide content is kept at 0.2% by mass or less even after the heat cycle test. Therefore, according to the above-described boron nitride powder, it is possible to improve the long-term insulating properties of the thermally conductive insulating material. Hereinafter, the boron nitride powder having such a property (the property of being less likely to cause an increase in the boron oxide content in the above-described heat cycle test) will be referred to as a boron nitride powder having excellent weather resistance.

The lower limit value of the boron oxide content after the heat cycle test may be 0% by mass, or it may be 0.001% by mass, 0.002% by mass, 0.005% by mass, 0.01% by mass, 0.02% by mass, or 0.03% by mass.

The boron oxide content is a content based on the total mass of the boron nitride powder, and it can be measured by the following procedure.
(1) After drying a boron nitride powder at 120° C. for 2 hours, 5 g of the dried boron nitride powder is accurately weighed out into a flat weighing tube and mixed with 15 ml of methanol (special grade reagent) to obtain a mixed liquid.
(2) The mixed liquid obtained in (1) described above is allowed to stand on a hot plate at 80° C. for 1 hour, and then dried in a dryer at 120° C. for 1.5 hours to vaporize the methanol, thereby obtaining a boron nitride powder from which boron oxide has been removed.
(3) The boron nitride powder obtained in (2) described above is cooled to room temperature (for example, 25° C.) in a desiccator.
(4) The mass (unit: g) of the boron nitride powder after cooling is weighed, and the boron oxide content is calculated according to the following formula.

$$Boron oxide content ( \% by mass ) = \text{} [ ( mass of boron nitride powder ( 5 g ) ) - \text{} ( mass of boron nitride powder after cooling ) ] \text{} \times \text{} 100 \text{} / ( mass of boron nitride powder ( 5 g ) )$$

For the same reason as described above, the smaller the rate of increase in the boron oxide content due to the heat cycle test ((amount of increase in boron oxide content before and after heat cycle test)/(boron oxide content before heat cycle test)×100), the more preferable it is. The rate of increase in the boron oxide content may be 1000% or less, or it may be 900% or less, 800% or less, 500% or less, 300% or less, or 200% or less. There is no particular restriction on the lower limit value of the rate of increase in the boron oxide content; however, it may be 0%, 20%, or 50%.

The purity of the boron nitride powder may be 98.5% by mass or more, or it may be 99% by mass or more, 99.5% by mass or more, or 99.9% by mass or more. The upper limit value of the purity of the boron nitride powder may be 100% by mass, or it may be 99.9% by mass or 99.5% by mass.

The purity of the boron nitride powder in the present specification means a value determined by titration, which is described below. First, a sample of a boron nitride powder is subjected to alkali decomposition with sodium hydroxide, and ammonia is distilled from the decomposition liquid by a steam distillation method and then collected in an aqueous boric acid solution. This collected liquid is titrated as a target with a normal solution of sulfuric acid. The nitrogen atom (N) content in the sample is calculated from the titration results. From the obtained nitrogen atom content, the content of boron nitride in the sample is determined based on the following formula, whereby the purity of the boron nitride powder can be calculated. It is noted that the formula weight of boron nitride is set to 24.818 g/mol, and the atomic weight of the nitrogen atom is set to 14.006 g/mol.

$$Content of boron nitride in sample [ \% by mass ] = content of nitrogen atom ( N ) [ \% by mass ] \times 1.772$$

The moisture amount of the boron nitride powder may be 300 ppm by mass or less, or it may be 250 ppm by mass or less, 200 ppm by mass or less, or 100 ppm by mass or less. A boron nitride powder having a smaller moisture amount tends to exhibit more excellent weather resistance. Therefore, a boron nitride powder having such a moisture amount as described above tends to make it possible to further improve the long-term insulating properties of the thermally conductive insulating material. The lower limit value of the moisture amount may be 0 ppm by mass, or it may be 10 ppm by mass or 20 ppm by mass.

The moisture amount is a content of moisture based on the total mass of the boron nitride powder and means a value that is measured based on the Karl Fischer method in accordance with the description of JIS K0068:2001 “Test methods for moisture amount of chemical products”. Specifically, first, a predetermined amount of a measurement sample (boron nitride powder) is collected in an alumina board that has been subjected to dummy heating. This is allowed to stand in a furnace in which the temperature has been adjusted to a constant temperature of 25° C., and the moisture generated in a case where heating has been carried out to a measurement temperature (300° C.) is measured using nitrogen gas as a carrier gas according to a coulometric titration method. The obtained measured value is converted to a value per unit mass (1 g), whereby the moisture amount can be determined. As a measuring device, for example, a “Trace moisture measuring device CA-06” (product name) manufactured by Mitsubishi Chemical Corporation, or the like can be used. As a titration solution, for example, “AQUAMICRON AX” (trade name) manufactured by Mitsubishi Chemical Corporation can be used as a catholyte, and “AQUAMICRON CXU” (trade name) manufactured by Mitsubishi Chemical Corporation can be used as an anolyte.

The average particle diameter of the boron nitride powder may be from 10 to 90 μm. A boron nitride powder having such an average particle diameter tends to have more excellent weather resistance. In addition, in a case where the average particle diameter of the boron nitride powder is 90 μm or less, a layer formed from a resin composition (for example, a thermally conductive insulating material) can be made thinner. In addition, in a case where the average particle diameter of the boron nitride powder is 10 μm or more, the thermal conductivity of the resin composition can be further improved. From these points of view, the average particle diameter of the boron nitride powder may be 80 μm or less or 70 μm or less, may be 20 μm or more or 30 μm or more, or may be 20 to 80 μm or 30 to 70 μm.

In the present specification, the average particle diameter means a 50% cumulative diameter (median diameter) in a volume-based cumulative particle size distribution. More specifically, it means a particle diameter (DS0) at which a cumulative value in a volume-based cumulative particle size distribution of a powder, which is obtained by a laser diffraction scattering method, reaches 50%. The laser analysis scattering method is measured in accordance with the method described in ISO 13320:2009. For the measurement, it is possible to use a laser diffraction scattering particle size distribution analyzer or the like. As the laser diffraction scattering particle size distribution analyzer, for example, “LS-13320” (product name) manufactured by Beckman Coulter Inc. can be used. In the measurement, a treatment with a homogenizer is not carried out, and the measurement is carried out in a state where agglomerated particles are present.

The specific surface area of the boron nitride powder may be 5.0 m²/g or less, or it may be 4.5 m²/g or less, 4.0 m²/g or less, 3.5 m²/g or less, or 3.0 m²/g or less. A boron nitride powder having a smaller specific surface area tends to have a smoother surface of the primary particle of the boron nitride and to have higher crystallinity, and the boron nitride powder tends to have more excellent weather resistance. Therefore, a boron nitride powder having such a specific surface area as described above tends to make it possible to further improve the long-term insulating properties of the thermally conductive insulating material. In addition, in a case where the specific surface area of the boron nitride powder is 5.0 m²/g or less, the primary particles of boron nitride are moderately large, and the void ratio within the agglomerated particles can be increased. Therefore, it is possible to facilitate the permeation of a resin into agglomerated particles in a case where the agglomerated particles are kneaded with the resin, and thus it is possible to further improve the insulating properties of a resin composition (for example, a thermally conductive insulating material). The specific surface area of the boron nitride powder may be 1.6 m²/g or more, 1.8 m²/g or more, or 2.0 m²/g or more. According to a boron nitride powder having such a specific surface area, it is possible to suppress a decrease in the density of the primary particles in the agglomerated particles, and it is possible to suppress a decrease in heat dissipation properties of a resin composition (for example, a thermally conductive insulating material) that is obtained by kneading with a resin. From these points of view, the specific surface area of the boron nitride powder may be 1.6 to 5.0 m²/g, 1.8 to 4.5 m²/g, or 2.0 to 4.0 m²/g. It is noted that the specific surface area of the boron nitride powder can be adjusted, for example, by controlling the grain growth of primary particles in producing the boron nitride powder.

The specific surface area in the present specification means a value that is measured using a specific surface area measuring device in accordance with the description of JIS Z8830:2013 “Determination of the specific surface area of powders (solids) by gas adsorption”, and it is a value that is calculated by applying a BET single point method using nitrogen gas.

The orientation index of the boron nitride powder may be 15 or less, or it may be 12 or less, or 10 or less. In a case where the orientation index of the boron nitride powder is within the above-described range, even if at least a part of the agglomerated particles collapses during kneading with a resin and the orientation increases, it is possible to suppress the occurrence of large anisotropy in the heat dissipation properties or the like of the resin composition. The orientation index may be 3 or more, 4 or more, or 6 or more, or it may be 3 to 15, 4 to 12, or 6 to 10. The orientation index of the boron nitride powder can be adjusted, for example, by controlling the growth of primary particles in producing the boron nitride powder.

The orientation index of the boron nitride powder in the present specification means a value that is measured according to the following method. First, an X-ray diffraction spectrum of the boron nitride powder is acquired by subjecting a boron nitride powder to an X-ray diffraction measurement, and peak intensities I(002) and I(100), which respectively correspond to the (002) plane and (100) plane, are acquired from the X-ray diffraction spectrum. The obtained peak intensities are used to calculate the orientation index [I(002)/I (100)] of the boron nitride powder. As the X-ray diffraction device, for example, “ULTIMA-IV” (product name) manufactured by Rigaku Corporation is used.

The agglomerated particles contained in the boron nitride powder may have a crushing strength of 4 MPa or more. The crushing strength of the agglomerated particles contained in the boron nitride powder may be 5 MPa or more, 8 MPa or more, or 10 MPa or more, from the viewpoint that the agglomerated particles are unlikely to collapse in a case of being kneaded with a resin. In general, when the graphitization index of the boron nitride powder is decreased, the voids inside the agglomerated particles become larger due to particle growth, and the crushing strength of the agglomerated particles also becomes low. Therefore, it is difficult to set the crushing strength of the agglomerated particles to 5 MPa or more while setting the graphitization index of the boron nitride powder to 2.0 or less. However, as will be described later, it is possible to achieve both such a low graphitization index and such a high crushing strength by devising the firing conditions (for example, the temperature rising rate) in the decarbonization-crystallization step in producing the boron nitride powder and allowing the particles to grow so that the voids inside the agglomerated particles do not become too large. The crushing strength of the agglomerated particles may be 20 MPa or less, 15 MPa or less, or 12 MPa or less. In a case where the crushing strength of the agglomerated particles is 20 MPa or less, at least a part of the agglomerated particles collapse moderately during kneading with a resin, and thus the generation of voids is easily suppressed. As a result, a resin composition to be obtained has higher insulating properties. From the above-described viewpoint, the crushing strength of the agglomerated particles may be, for example, 4 to 20 MPa, 5 to 20 MPa, 8 to 15 MPa, or 10 to 12 MPa.

The crushing strength in the present specification means a value that is measured in accordance with the description in JIS R1639-5:2007 “Test methods of properties of fine ceramic granules Part 5: Compressive strength of a single granule”. A crushing strength σ (unit: MPa) of one agglomerated particle is calculated from values of the dimensionless number α (α=2.48), which changes depending on the position within the agglomerated particle, the crushing test force P(unit: N), and the particle diameter d (unit: μm), by using the formula σ=α×P/(π×d²). The measurement was performed on 20 or more agglomerated particles, and the value at the time when the cumulative destruction rate reaches 63.2% was calculated. A micro-compression tester can be used for the measurement. As the micro-compression tester, for example, “MCT-210” (product name) manufactured by Shimadzu Corporation can be used.

### <Method for Producing Boron Nitride Powder>

A method for producing a boron nitride powder according to one embodiment includes a decarbonization-crystallization step of firing and cooling a raw material mixture containing a boron carbonitride powder and a boron source to generate primary particles of boron nitride and obtaining a powder containing agglomerated particles formed by agglomeration of primary particles, where in the decarbonization-crystallization step, the raw material mixture is fired and cooled in a closed space having a nitrogen gas concentration of 99.90% by volume or more and a leakage amount of 270×10⁻⁴ Pa·m³/sec or less.

Since volatile components (boron oxide and the like) are generated in the decarbonization-crystallization step, the decarbonization-crystallization step is usually carried out in an open space that allows the outflow and inflow of gas. On the other hand, in the present embodiment, since the firing and cooling in the decarbonization-crystallization step are carried out in such a closed space as described above, it is possible to not only reduce the boron oxide content in the finally obtained boron nitride powder but also obtain a boron nitride powder having excellent weather resistance. Although the reason why a boron nitride powder having excellent weather resistance can be obtained is not clear, a conceivable reason is that the above method makes it easy to obtain a boron nitride powder having high crystallinity of primary particles and having high purity of hexagonal boron nitride. In other words, it is presumed that the boron oxide content is less likely to increase in the use environment since the crystallinity of the primary particles contained in the boron nitride powder increases, and the purity of the hexagonal boron nitride increases.

It is noted that in the present specification, the term “closed space” means a space that is isolated from the external environment to the extent that the leakage amount of gas is equal to or smaller than the above-described upper limit value, and the closed space may not be completely isolated (to the extent that gas cannot flow out or flow in) from the external environment. The closed space is usually a space that is formed by partitioning a part of the inside of a firing furnace. The closed space may be, for example, a space defined by an inner wall, a door, a lid, and the like of a firing furnace, or may be an inner space of a container or the like, which is independent of the firing furnace. In the present embodiment, in order to minimize the influence of volatile components that are generated in the decarbonization-crystallization step, a mechanism for capturing the volatile components may be provided in the closed space.

In the present specification, the “leakage amount” is determined by the fluctuation range of the pressure in a closed space in a case where the inside of the closed space is made into a vacuum state and then a predetermined time has elapsed. Specifically, for example, the measurement can be carried out by the following procedure.
(1) A vacuum pump is used to evacuate a closed space, and the evacuation is stopped after the pressure (degree of vacuum) in the closed space has reached a targeted degree of vacuum.
(2) One hour after the evacuation has been stopped, measurement is carried out for the pressure (degree of vacuum) in the closed space.
(3) Using the pressure at the time when the evacuation has been stopped (initial pressure), the pressure determined in (2) (final pressure), and the volume of the closed space, the leakage amount is determined according to the following formula.

$$Leakage \text{} amount \text{} ( Pa \cdot {m}^{3} \text{} / \text{} sec ) \text{} = [ \text{} ( final \text{} pressure - \text{} initial pressure ) \times \text{} volume of closed space ] \text{} / 3 , 600 \text{}$$

The method for producing a boron nitride powder according to one embodiment may further include a step (preparation step) of preparing a boron carbonitride powder that is used in the decarbonization-crystallization step. In addition, the method for producing a boron nitride powder according to one embodiment may further include a step (pulverization step) of pulverizing agglomerated particles in the powder obtained in the decarbonization-crystallization step. In addition, the method for producing a boron nitride powder according to one embodiment may further include a step (washing step) of washing the powder obtained in the decarbonization-crystallization step or a pulverized product thereof.

Hereinafter, each step in the method for producing a boron nitride powder will be described in detail.

### (Preparation Step)

The preparation step includes, for example, a pressurized nitriding step of firing a boron carbide powder (BAC powder) in a pressurized nitrogen atmosphere. In the pressurized nitriding step, the boron carbide in the boron carbide powder is subjected to nitriding to obtain a fired material containing boron carbonitride. According to the pressurized nitriding step, it is possible to obtain a fired material containing hexagonal boron carbonitride at high purity.

The boron carbide powder is an agglomerate of boron carbide particles. The purity of the boron carbide powder (the content of boron carbide) may be 96.0% by mass or more or may be 98.0% by mass or more. As the boron carbide powder, a commercially available boron carbide powder may be used, or a separately prepared boron carbide powder may be used. The boron carbide powder can be obtained by, for example, a method that includes a step of mixing boric acid and acetylene black and then heating the resultant mixture in an inert gas atmosphere at 1,800° C. to 2,400° C. for 1 to 10 hours to obtain a boron carbide lump, and a step of pulverizing the obtained boron carbide lump, subsequently sieving the pulverized boron carbide lump and appropriately carrying out washing, impurity removal, drying, and the like to prepare a boron carbide powder.

The firing and the cooling after firing in the pressurized nitriding step are usually carried out in a closed space having a leakage amount of 270×10⁻⁴ Pa·m³/sec or less. The details of the closed space are omitted since they are the same as those of the closed space in which the firing and the cooling after firing in the decarbonization-crystallization step are carried out.

The firing temperature in the pressurized nitriding step is preferably higher than the firing temperature in the decarbonization-crystallization step. The firing temperature in the pressurized nitriding step may be, for example, 1,900° C. to 2,200° C., 2,000° C. to 2,200° C., or 2,100° C. to 2,200° C. In a case where the firing temperature is set within the above-described range, the crystallinity of boron carbonitride can be improved, and the proportion of hexagonal boron carbonitride can be increased. The firing time in the pressurized nitriding step is not particularly limited as long as it is in a range in which the nitriding proceeds sufficiently, and the firing time may be, for example, 6 to 30 hours, 8 to 25 hours, or 10 to 20 hours.

The atmospheric pressure in the pressurized nitriding step may be, for example, 0.6 to 1.0 MPa, 0.7 to 1.0 MPa, or 0.8 to 1.0 MPa. In a case where the atmospheric pressure is set within the above-described range, it is possible to allow the nitriding of boron carbide to proceed efficiently and sufficiently while suppressing the manufacturing cost. It is noted that the above atmospheric pressure is indicated as a gauge pressure.

The nitrogen gas concentration of the pressurized nitrogen atmosphere in the pressurized nitriding step may be, for example, 95.00% by volume or more, 98.00% by volume or more, or 99.90% by volume or more. In a case where the nitrogen gas concentration is set within the above-described range, the nitriding of boron carbide can be carried out under milder conditions. It is noted that the above nitrogen gas concentration is based on the volume in the standard state.

The fired material obtained in the pressurized nitriding step may be used, as it is, in the decarbonization-crystallization step, or may be used in the decarbonization-crystallization step after being appropriately subjected to a pulverization treatment, a classification treatment, a washing treatment, a heating treatment (for example, an oxidation treatment in an atmosphere containing oxygen), and the like. That is, the preparation step may further include a step of carrying out a pulverization treatment, a classification treatment, a washing treatment, a heating treatment (for example, an oxidation treatment in an atmosphere containing oxygen), and the like. The pulverization treatment can be carried out using a general pulverizer such as a ball mill, a vibration mill, or a jet mill, or a cracking machine. It is noted that in the present specification, “pulverization” also includes “cracking”

### (Decarbonization-Crystallization Step)

In the decarbonization-crystallization step, a boron carbonitride powder (B₄CN₄ powder) is fired together with a boron source, which makes it possible to decarbonize the boron carbonitride and concurrently increase the degree of crystallization of the boron nitride. As a result, a boron nitride powder (BN powder) containing agglomerated particles in which primary particles of boron nitride are agglomerated is obtained. The boron nitride in the boron nitride powder obtained by this method is usually hexagonal boron nitride and includes agglomerated particles in which scaly primary particles of hexagonal boron nitride are agglomerated.

The boron carbonitride powder is an agglomerate of boron carbonitride particles. The purity of the boron carbonitride powder (the content of boron carbonitride) may be 98.0% by mass or more. As the boron carbonitride powder, a commercially available boron carbonitride powder may be used, or a powder prepared in the above preparation step may be used. In a case where a boron carbonitride powder having a high proportion of hexagonal boron carbonitride is used as the boron carbonitride powder, the proportion of hexagonal boron nitride in the boron nitride powder to be obtained can be increased. Similarly, in a case where a boron carbonitride powder obtained through the above-described pressurized nitriding step is used, the proportion of hexagonal boron nitride in the boron nitride powder to be obtained can be increased.

The boron source includes, for example, boric acid and boron oxide. One kind of these may be used alone, or two or more kinds thereof may be used in combination. In a case where boric acid is used as a boron source, the effect of promoting the growth of primary particles is easily obtained. The amount of the boron source to be used may be, for example, 25% to 50% by mass based on the total mass of the raw material mixture.

In the decarbonization-crystallization step, a material other than the boron carbonitride powder and the boron source may be used. For example, a carbonate may be used in addition to the boron source. In other words, the raw material mixture may further contain a carbonate. Examples of the carbonate include sodium carbonate, calcium carbonate, and strontium carbonate. One kind of these may be used alone, or two or more kinds thereof may be used in combination. In a case where sodium carbonate is used as the carbonate, the effect of promoting the growth of primary particles is easily obtained. The amount of the carbonate to be used may be, for example, 1% to 10% by mass based on the total mass of the raw material mixture.

The leakage amount in the closed space in which the firing and the cooling in the decarbonization-crystallization step are carried out may be 250×10⁻⁴ Pa·m³/sec or less, or 200×10⁻⁴ Pa·m³/sec or less, from the viewpoint of easily obtaining a boron nitride powder having excellent weather resistance. The lower limit value of the leakage amount in the closed space may be 0 Pa m³/sec, or it may be 0.1×10 4 Pa·m³/sec or 0.5×10⁻⁴ Pa·m³/sec.

The nitrogen gas concentration in the closed space (the nitrogen gas concentration in the atmosphere during firing) may be 99.95% by volume or more from the viewpoint of easily obtaining a boron nitride powder having excellent weather resistance. The upper limit value of the nitrogen gas concentration is not particularly limited; however, it may be 100% by volume or 99.99% by volume.

The atmospheric pressure during firing in the decarbonization-crystallization step may be 1 kPa or more, or it may be 2 kPa or more or 3 kPa or more. In a case where the atmospheric pressure is set to 3 kPa or more, the crystallinity of boron nitride can be further increased, which makes it easy to obtain a boron nitride powder having excellent weather resistance. The atmospheric pressure during firing in the decarbonization-crystallization step may be 100 kPa or less, or it may be 90 kPa or less, or 80 kPa or less. In a case where the atmospheric pressure is set to 80 kPa or less, it is possible to further suppress the collapse of the agglomerated particles during the decarbonization-crystallization step. From the above-described viewpoint, the atmospheric pressure during firing in the decarbonization-crystallization step may be 1 to 100 kPa, 2 to 90 kPa, or 3 to 80 kPa. It is noted that the above atmospheric pressure is indicated as a gauge pressure.

The firing temperature in the decarbonization-crystallization step may be 1,900° C. or higher or may be 2,000° C. or higher. In a case where the firing temperature is set to 1,900° C. or higher, not only the growth of primary particles proceeds sufficiently, but also a boron nitride powder having excellent weather resistance is easily obtained. The firing temperature in the decarbonization-crystallization step may be 2,400° C. or lower, or it may be 2,200° C. or lower, or 2,100° C. or lower. In a case where the firing temperature is set to 2,400° C. or lower, the yellowing of the boron nitride powder can be suppressed. From the above-described viewpoint, the firing temperature in the decarbonization-crystallization step may be, for example, 1,900° C. to 2,400° C., 1,900° C. to 2,200° C., or 2,000° C. to 2,100° C. It is noted that the firing temperature means a holding temperature during heating (firing). The heating start temperature is not particularly limited; however, it may be room temperature (for example, 25° C.). In a case where heating is started from a temperature lower than the holding temperature, the temperature rising rate up to 1,000° C. may be, for example, 0.5 to 10.0° C./min, 2.0 to 10.0° C./min, or 0.5 to 5.0° C./min, and the temperature rising rate at 1,000° C. or higher may be, for example, 0.1 to 5.0° C./min, 0.5 to 5.0° C./min, or 2.0 to 4.0° C./min.

The firing time in the decarbonization-crystallization step may be 2 hours or more, or may be 3 hours or more, or 4 hours or more. In a case where the firing time is set to 2 hours or more, not only the growth of primary particles proceeds further sufficiently, but also a boron nitride powder having excellent weather resistance is easily obtained. The firing time in the decarbonization-crystallization step may be 40 hours or less, or it may be 30 hours or less, or 20 hours or less. In a case where the firing time is set to 40 hours or less, it is possible to suppress an increase in manufacturing cost. From the above-described viewpoint, the firing time in the decarbonization-crystallization step may be, for example, 4 to 40 hours, 6 to 30 hours, or 8 to 20 hours. It is noted that the firing time means a holding time at the holding temperature.

As described above, in a case where the firing conditions in the decarbonization-crystallization step are changed, it is possible to further increase the crushing strength of the agglomerated particles in the boron nitride powder while decreasing the graphitization index of the boron nitride powder. Specifically, in a case where the raw material mixture is fired by being heated from a temperature of 1,000° C. or lower to a holding temperature of 1,900° C. or higher at a temperature rising rate of 0.5 to 5.0° C./min and being held at the holding temperature for 2 hours or more, a boron nitride powder in which the graphitization index is 2.0 or less and the crushing strength of the agglomerated particles is 5 MPa or more is easily obtained. From the viewpoint of further increasing the crushing strength while further decreasing the graphitization index, the temperature rising rate may be set to 1.0 to 5.0° C./min or may be set to 2.0 to 4.0° C./min.

After firing, the boron nitride powder may be allowed to be cooled sufficiently within the closed space. The temperature of the boron nitride powder in a case where the closed space is opened to the external environment (for example, the atmospheric air) may be 40° C. or lower.

### (Pulverization Step)

In the pulverization step, agglomerated particles in the powder (boron nitride powder) obtained in the decarbonization-crystallization step are pulverized. The agglomerated particles to be pulverized in the pulverization step are mainly agglomerated particles (so-called tertiary particles) formed by further agglomerating mutually the agglomerated particles (so-called secondary particles), which are formed by agglomeration of primary particles of boron nitride. According to the pulverization step, the tertiary particles in the boron nitride powder are pulverized, which makes it possible to increase the proportion of the secondary particles.

According to the studies carried out by the inventors of the present invention, a method for the pulverization treatment in the pulverization step can also affect the weather resistance of the boron nitride powder. The pulverization treatment may be carried out by an impact type pulverization method which uses a general pulverizer such as a pin mill, a jet mill, a vibration mill, a planetary mill, an attritor mill, or a bead mill, or a cracking machine; however, it may be carried out by a grinding/shearing type pulverization method which uses a grinding machine, a stone mill type pulverizer, a feather mill, or the like. The latter pulverization method tends to make it possible to obtain a boron nitride powder having higher weather resistance. The grinding/shearing type pulverization method may be a method that uses a stone mill type pulverizer and a feather mill, which are capable of continuously carrying out pulverization (grinding). In a case where the agglomerated particles are pulverized by frictional shearing, the grinding and shearing may be carried out after carrying out a pulverization treatment by impact or compression.

### (Washing Step)

In the washing step, the powder (boron nitride powder) obtained in the decarbonization-crystallization step or a pulverized product thereof is washed. The washing step may be, for example, a step of bringing a boron nitride powder or a pulverized product thereof into contact with an acid to subject it to a wet type treatment and then carrying a washing treatment until the electric conductivity of the washing liquid reaches 0.7 mS/m or less. In a case where such a washing step is carried out, it is possible to reduce the boron oxide content in the boron nitride powder. It is noted that the term “pulverized product” is a powder obtained through the above-described pulverization step and may be such as one that has been subjected to a classification treatment or the like after the pulverization step.

The wet type treatment can be carried out, for example, by immersing the boron nitride powder or a pulverized product thereof in an acid and stirring the resultant mixture. The acid that is used in the wet type treatment may be, for example, dilute nitric acid, concentrated nitric acid, or the like. As the acid that is used in the wet type treatment, for example, hydrochloric acid, hydrofluoric acid, sulfuric acid, or the like can be used; however, the use of these acids may generate ionic impurities derived from the acids. On the other hand, the use of nitric acid makes it easy to suppress the generation of ionic impurities. The time for coming into contact with the acid in the wet type treatment may be, for example, 10 minutes to 5 hours.

The washing treatment is carried out by bringing the boron nitride powder into contact with a washing liquid. The washing liquid is usually a liquid containing water, and water, ion exchange water, or the like is used. As the washing liquid, a mixed solution of an organic solvent and water can also be used. In a case where the washing liquid contains a component other than water, the content of water in the washing liquid may be 60% by mass or more based on the total mass of the washing liquid. The washing treatment may be carried out, for example, by a method of mixing a boron nitride powder or a pulverized product thereof after the wet type treatment with a washing liquid and stirring the resultant mixture. The amount of the washing liquid to be used may be, for example, 100 to 500 parts by mass with respect to 100 parts by mass of the boron nitride powder (or a pulverized product thereof). The temperature of the washing liquid may be, for example, 50° C. to 90° C. The washing liquid may be stirred using, for example, a stirrer, a magnetic stirrer, a disperser, or the like. The stirring time may be, for example, 30 to 180 minutes. The stirring speed may be, for example, 10 to 100 rpm. The washing treatment may be repeated several times. For example, a series of operations, in which a boron nitride powder and a washing liquid are mixed and stirred, the boron nitride powder is subsequently separated from the washing liquid, and the separated boron nitride powder is mixed again with a fresh washing liquid, may be repeated. In the washing treatment, washing may be carried out until the electric conductivity of the washing liquid reaches 0.7 mS/m or less or may be carried out until the electric conductivity of the washing liquid reaches 0.5 mS/m or less, 0.3 mS/m or less, or 0.2 mS/m or less.

The washing step may be carried out before the pulverization step; however, a higher washing effect is likely to be obtained in a case where the washing step is carried out after the pulverization step. That is, a higher washing effect is likely to be obtained in a case where the pulverized product (boron nitride powder) obtained in the decarbonization-crystallization step is subjected to the washing step.

The boron nitride powder after the decarbonization-crystallization step may be subjected to a treatment other than the above-described pulverization and washing. For example, a classification treatment may be carried out in order to obtain a boron nitride powder having a desired average particle diameter. The classification treatment is usually carried out after the pulverization treatment. In addition, for example, in a case where the boron nitride powder contains magnetized particles, a treatment for removing the magnetized particles may be carried out. The treatment for removing the magnetized particles is usually carried out on a slurry that contains a boron nitride powder or a pulverized product thereof, and water (for example, a slurry that contains the boron nitride powder or a pulverized product thereof after the above-described washing treatment). Specifically, for example, an electromagnetic demetallization device (for example, an electromagnetic deironization device) and a magnetic demetallization device (for example, a magnetic deironization device) can be used. The lower limit value of the magnetic flux density of the magnetic field applied to the slurry may be, for example, 0.5 T or more, 0.6 T or more, 1.0 T or more, or 1.3 T or more. The upper limit value of the magnetic flux density of the magnetic field applied to the slurry may be, for example, 1.8 T or less, 1.7 T or less, or 1.6 T or less. The magnetic flux density of the magnetic field applied to the slurry can be adjusted within the range described above, and it may be, for example, 0.5 to 1.8T.

In the method for producing a boron nitride powder described above, it is possible to obtain a boron nitride powder having excellent weather resistance. More specifically, it is possible to obtain, for example, a boron nitride powder that includes agglomerated particles formed by agglomeration of primary particles of boron nitride, where a graphitization index is 2.0 or less, a boron oxide content is 0.1% by mass or less, and the above-described boron oxide content after the heat cycle test is 0.2% by mass or less.

### <Resin Composition>

A resin composition according to one embodiment contains the boron nitride powder according to the embodiment. The resin composition is used for, for example, a thermally conductive insulating material. Examples of the thermally conductive insulating material include an insulating layer of a printed wiring board that is used in electronic components such as a power device, a transistor, a thyristor, and a CPU, and a thermal interface material.

As a resin contained in the resin composition, a publicly known resin that is used in a thermally conductive insulating material can be used. Examples of the resin include a liquid crystal polymer, a fluororesin, a silicone resin, a silicone rubber, an acrylic resin, a polyolefin (polyethylene or the like), an epoxy resin, a phenol resin, a melamine resin, a urea resin, an unsaturated polyester, a polyimide, a polyamideimide, a polyetherimide, polybutylene terephthalate, polyethylene terephthalate, polyphenylene ether, polyphenylene sulfide, a fully aromatic polyester, a polysulfone, a polyethersulfone, a polycarbonate, a maleimide-modified resin, an ABS (acrylonitrile-butadiene-styrene) resin, an AAS (acrylonitrile-acrylic rubber-styrene) resin, and an AES (acrylonitrile-ethylene-propylene-diene rubber-styrene) resin.

The resin content may be, for example, 15% by volume or more, 20% by volume or more, or 30% by volume or more, based on the total volume of the resin composition. The resin content may be, for example, 60% by volume or less, 50% by volume or less, or 40% by volume or less, based on the total volume of the resin composition.

The content of the boron nitride powder may be, for example, 30% by volume or more, 40% by volume or more, 50% by volume or more, or 60% by volume or more, based on the total volume of the resin composition. The content of the boron nitride powder may be, for example, 85% by volume or less, 80% by volume or less, or 70% by volume or less, based on the total volume of the resin composition. The resin composition may further contain, in addition to the resin and the boron nitride powder, a curing agent for curing the resin. The curing agent can be appropriately selected depending on the kind of resin. In a case where the resin is an epoxy resin, examples of the curing agent include a phenol novolac compound, an acid anhydride, an amino compound, and an imidazole compound. The content of the curing agent may be, for example, 0.5 part by mass or more, or 1.0 part by mass or more, with respect to 100 parts by mass of the resin. The content of the curing agent may be, for example, 15.0 parts by mass or less, or 10.0 parts by mass or less, with respect to 100 parts by mass of the resin.

### EXAMPLES

The contents of the present disclosure will be described in more detail with reference to examples and comparative examples; however, the present disclosure is not limited to the following examples.

It is noted that the leakage amount in the closed space in the heating furnace, which was used in the following Examples and Comparative Examples, was measured by the following procedure.
(1) A vacuum pump was used to evacuate a closed space, and the evacuation was stopped after the pressure (degree of vacuum) in the closed space had reached a targeted degree of vacuum.
(2) One hour after the evacuation was stopped, measurement was carried out for the pressure (degree of vacuum) in the closed space.
(3) Using the pressure at the time when the evacuation was stopped (initial pressure: 1 Pa), the pressure determined in (2) (final pressure), and the volume of the closed space, the leakage amount was determined according to the following formula.

$$Leakage \text{} amount \text{} ( Pa \cdot {m}^{3} \text{} / \text{} sec ) \text{} = [ \text{} ( final \text{} pressure - \text{} initial pressure ) \times \text{} volume of closed space ] \text{} / 3 , 600 \text{}$$

### Example 1

### [Preparation of Boron Carbide Powder]

100 parts by mass of orthoboric acid, manufactured by Nippon Denko Co., Ltd., and 35 parts by mass of acetylene black (trade name: HS100L) manufactured by Denka Company Limited were mixed using a Henschel mixer. A graphite crucible was filled with the obtained mixture and heated in an arc furnace in an argon atmosphere at 2,200° C. for 6 hours to obtain lumpy boron carbide (BAC). The obtained lumpy material was coarsely pulverized with a jaw crusher to obtain a coarse powder. The obtained coarse powder was further pulverized with a ball mill having silicon carbide balls (diameter: 10 mm) to obtain a pulverized powder. The pulverization using the ball mill was carried out at a rotation speed of 25 rpm for 60 minutes. Thereafter, using a vibrating sieve having a mesh opening of 63 μm, the pulverized powder was classified to prepare a boron carbide powder (BAC powder) having an average particle diameter of 20 μm. The boron carbide powder had a specific surface area of 0.4 m²/g and a purity of 98% by mass.

The average particle diameter of the boron carbide powder was measured using a laser diffraction scattering particle size distribution analyzer (device name: LS-13320) manufactured by Beckman Coulter Inc. in accordance with the description of ISO 13320:2009. It is noted that the boron carbide powder was not subjected to a treatment with a homogenizer. In a case of measuring the particle size distribution, water was used as a solvent for dispersing the boron carbide powder, and hexametaphosphoric acid was used as a dispersant. In this case, a numerical value of 1.33 was used as the refractive index of water, and a numerical value of 2.6 was used as the refractive index of the boron carbide powder.

The purity of the boron carbide powder was calculated from the sum of the carbon amount and the boron amount. The carbon amount was calculated according to the combustion infrared absorption spectrometry, and the boron amount was calculated according to the ICP emission spectroscopy.

### [Pressurized Nitriding Step]

The prepared boron carbide powder was fired for 12 hours in a closed space (leakage amount: 270×10⁻⁴ Pa·m³/sec) in a carbon-type resistive heating furnace. In this case, the firing atmosphere was set to a nitrogen gas atmosphere (nitrogen gas concentration: 99.99% by volume or more), the firing temperature was set to 2,050° C., and the atmospheric pressure was set to 0.90 MPa. In this manner, a fired material (powder) containing boron carbonitride was obtained. The fired material was analyzed by a powder X-ray diffraction (XRD) method to confirm the disappearance of boron carbide and the formation of boron carbonitride.

### [Atmospheric Air Heating Step]

A mullite container was filled with the fired material obtained in the pressurized nitriding step and subjected to a heat treatment in a muffle furnace at 700° C. for 12 hours in an atmospheric air atmosphere.

### [Decarbonization-Crystallization Step]

The fired material after the atmospheric air heating step, boric acid, and sodium carbonate were mixed in a Henschel mixer to obtain a raw material mixture. The amount of boric acid to be used was set to 35% by mass based on the total mass of the raw material mixture, and the amount of sodium carbonate to be used was set to 5% by mass based on the total mass of the raw material mixture. Next, a crucible made of boron nitride was filled with the obtained raw material mixture and subjected to a drying treatment with a dryer at 200° C. for 12 hours. Next, the crucible was taken out from the dryer, and firing was carried out for 5 hours in a closed space (leakage amount: 150×10⁻⁴ Pa·m³/sec) in a resistive heating furnace, and then cooling was carried out to room temperature (25° C.) in the closed space. In this case, the nitrogen gas concentration in the firing atmosphere (the nitrogen gas concentration in the closed space) was set to 99.95% by volume, the firing temperature was set to 2,000° C., and the atmospheric pressure was set to 0.01 MPa. In addition, the heating to the firing temperature was started from room temperature, the temperature was increased to 1,000° C. at a temperature rising rate of 4° C./min, and then the temperature was increased from 1,000° C. to 2000° C. at a temperature rising rate of 2° C./min.

### [Pulverization Step]

The powder obtained in the decarbonization-crystallization step (the powder after firing) was subjected to a pulverization treatment by a non-impact type pulverization method. Specifically, the powder after firing was coarsely pulverized with a jaw crusher manufactured by Makino Corporation, and then the coarsely pulverized powder was subjected to cracking with a frictional shearing type cracking machine (MULTIMILL, manufactured by GROW ENGINEERING Co., Ltd.) to pulverize the agglomerated particles in the powder. Thereafter, the obtained pulverized product was classified by being allowed to pass through a sieve having a mesh opening of 75 μm, thereby obtaining a boron nitride powder of Example 1, which includes agglomerated particles formed by agglomeration of primary particles of hexagonal boron nitride.

### Example 2

A boron nitride powder of Example 2 was obtained in the same manner as in Example 1, except that the amount of sodium carbonate to be used in the decarbonization-crystallization step was adjusted to 0.5% by mass based on the total mass of the raw material mixture.

### Example 3

A boron nitride powder of Example 3 was obtained in the same manner as in Example 1, except that the pulverized product obtained in the pulverization step was classified by being allowed to pass through a sieve having a mesh opening of 75 μm, and then the obtained powder was subjected to the following washing step.

### [Washing Step]

40 g of the classified powder was added to 400 g of dilute nitric acid (nitric acid concentration: 1% by mass) to prepare a solution, and the solution was stirred at room temperature for 60 minutes. After stirring, the solution was allowed to stand for one hour, the supernatant liquid was discarded by decantation, and ion exchange water was added thereto, and stirring was carried out for 30 minutes. Thereafter, solid-liquid separation was carried out by suction filtration, and the filtrate was washed, by replacing the water, until it became neutral. The washing was continued until the electric conductivity of the washing liquid (water) reached finally 0.2 mS/m. In a case where it was confirmed that the electric conductivity of the washing liquid was 0.2 mS/m, the solid content (cake portion) obtained by filtration was subjected to the following treatment for removing magnetized particles.

First, the solid content was mixed with ion exchange water at 25° C. to prepare 10 L of an aqueous slurry having a solid content concentration of 30% by mass. Next, 10 L of the above-described aqueous slurry was charged into a 20 L resin container. Next, the aqueous slurry in the resin container was stirred at 100 rpm using a stirrer manufactured by Yamato Scientific Co., Ltd. (trade name: Laboratory Stirrer LR500B (equipped with an all-PTFE-coated stirring rod attached with a blade having a length of 100 mm)). Next, in an electromagnetic deironization machine capable of carrying out a wet type treatment, ten screens each having a mesh structure with a mesh opening of 0.5 mm were superposed in a vertical direction, and the excitation current of the electromagnetic deironization machine was set so that the magnetic force of the screens was 14,000 G (1.4 T). Then, a tube pump manufactured by Watson-Marlow Limited (trade name: 704 UIP55 Washdown) was installed between the resin container containing the stirred aqueous slurry and the electromagnetic deironization machine, and the aqueous slurry was allowed to circulatively pass through a magnetic separation zone of the electromagnetic deironization machine from the bottom to the top at a flow rate of 0.2 cm/sec for 20 minutes. It is noted that a resin hose having an inner diameter of 12 mm was used as a flow path connecting the resin container to the electromagnetic deironization machine, and the length of the flow path was 5 m. After circulation, the obtained slurry was subjected to solid-liquid separation by suction filtration to obtain a solid content from which the magnetized particles had been removed. The solid content from which the magnetized particles had been removed was placed on a boron nitride plate and then heated at 400° C. for 30 minutes in a nitrogen atmosphere using a high-temperature dryer to obtain a dry powder. The dry powder was used as a boron nitride powder of Example 3.

### Example 4

A boron nitride powder of Example 4 was obtained in the same manner as in Example 3, except that the leakage amount in the closed space in the resistive heating furnace, which was used in the decarbonization-crystallization step, was changed to 5.5×10⁻⁴ Pa m³/sec and the nitrogen gas concentration in the firing atmosphere (the nitrogen gas concentration in the closed space) was increased up to 99,99% by volume.

### Example 5

A boron nitride powder of Example 5 was obtained in the same manner as in Example 4, except that, in [Preparation of boron carbide powder], the pulverization conditions and the classification conditions were changed so that the average particle diameter of the boron carbide powder to be obtained was 50 μm, that a boron carbide powder having an average particle diameter of 50 μm was used in [Pressurized nitriding step], and that the mesh opening of the sieve used in the pulverization step was changed to 150 μm.

### Example 6

A boron nitride powder of Example 6 was obtained in the same manner as in Example 4, except that, in [Preparation of boron carbide powder], the pulverization conditions and the classification conditions were changed so that the average particle diameter of the boron carbide powder to be obtained was 15 μm, that a boron carbide powder having an average particle diameter of 15 μm was used in [Pressurized nitriding step], and that the mesh opening of the sieve used in the pulverization step was changed to 45 μm.

### Example 7

A boron nitride powder of Example 7 was obtained in the same manner as in Example 4, except that, in [Preparation of boron carbide powder], the pulverization conditions and the classification conditions were changed so that the average particle diameter of the boron carbide powder to be obtained was 8 μm, that a boron carbide powder having an average particle diameter of 8 μm was used in [Pressurized nitriding step], and that the mesh opening of the sieve used in the pulverization step was changed to 53 μm.

### Comparative Example 1

A boron nitride powder of Comparative Example 1 was obtained in the same manner as in Example 1, except that in the decarbonization-crystallization step, an open-type firing furnace was used instead of the resistive heating furnace having a closed space, and the firing was carried out under normal pressure, and that in the pulverization step, the pulverization treatment was carried out with a high-speed rotary pulverizer Pin Mill (according to the impact type pulverization method) manufactured by NIPPON COKE & ENGINEERING CO., LTD. It is noted that nitrogen gas having a nitrogen gas concentration of 99.9% by volume was continuously supplied to the space in the open furnace, in which the powder was fired, whereby the firing atmosphere was made into a nitrogen gas atmosphere.

### Comparative Example 2

A boron nitride powder of Comparative Example 2 was obtained in the same manner as in Comparative Example 1, except that in the pulverization step, the powder after firing was coarsely pulverized with a jaw crusher manufactured by Makino Corporation, and then the coarsely pulverized powder was subjected to cracking with a frictional shearing type cracking machine (MULTIMILL, manufactured by GROW ENGINEERING Co., Ltd.) to carry out the pulverization treatment.

### Comparative Example 3

A boron nitride powder of Comparative Example 3 was obtained in the same manner as in Comparative Example 1, except that in the decarbonization-crystallization step, the firing temperature (holding temperature) was changed to 1,850° C. and the firing time (holding time) was changed to 15 hours.

### <Evaluation of Physical Properties>

Each of the boron nitride powders obtained in Examples 1 to 7 and Comparative Examples 1 to 3 was subjected to measurements of the boron oxide (B₂O₃) content, the graphitization index (G.I.), the orientation index, the purity, the moisture amount, the average particle diameter, the specific surface area, and the crushing strength before and after the heat cycle test, according to the measuring method methods described below. The results are shown in Table 1.

(B₂O₃ Content)

The boron oxide (B₂O₃) content in the boron nitride powder was measured by the following procedure.
(1) After drying a boron nitride powder at 120° C. for 2 hours, 5 g of the dried boron nitride powder was precisely weighed into a flat weighing tube and mixed with 15 ml of methanol (special grade reagent) to obtain a mixed liquid.
(2) The mixed liquid obtained in (1) described above was allowed to stand on a hot plate at 80° C. for 1 hour, and then dried in a dryer at 120° C. for 1.5 hours to vaporize the methanol, thereby obtaining a boron nitride powder from which boron oxide had been removed.
(3) The boron nitride powder obtained in (2) described above was cooled to room temperature (25° C.) in a desiccator.
(4) The mass of the boron nitride powder after cooling was weighed, and the boron oxide content was calculated according to the following formula.

Boron oxide content (% by mass)=[(mass of boron nitride powder (5 g))−(mass of boron nitride powder after cooling)]×100/(mass of boron nitride powder (5 g))

The average value obtained from three measurements by this method was defined as the boron oxide (B₂O₃) content.

Next, 10 g of the boron nitride powder was enclosed in a polyethylene sack equipped with a zipper, UNIPACK C-4. The sack in which the boron nitride powder was enclosed was placed in a thermo-hygrostat (manufactured by ETAC Division, Kusumoto Chemicals, Ltd., trade name: FX420N) that had been set in advance to a temperature of 0° C. and a humidity of 80% RH, and a heat cycle test of a total of 1,000 cycles was carried out, where one cycle was defined by the following operation (I).

(I) The sack is heated from 0° C. to 50° C. at a temperature rising rate of 3.0° C./min, and then held for 30 minutes and cooled from 50° C. to 0° C. at a cooling rate of 1.5° C./min, followed by being held for 30 minutes.

The boron oxide (B₂O₃) content in the boron nitride powder after the heat cycle test was measured in the same manner as described above.

### (Graphitization Index)

The graphitization index (G.I.) of the boron nitride powder was calculated from the measurement results obtained by the powder X-ray diffraction method. In an obtained X-ray diffraction spectrum, values (in any unit) of areas, each of which was enclosed by the integrated intensity of each diffraction peak (that is, each diffraction peak) corresponding to the (100) plane, (101) plane, and (102) plane of the primary particles of hexagonal boron nitride, and the baseline thereof, were calculated and denoted as $100, S101, and $102, respectively. Using the area values calculated in this way, the graphitization index was determined based on the Formula (1) below.

$$G . I . = ( S 100 + S 101 ) / S 102 \qquad ( 1 )$$

### (Orientation Index)

The orientation index of the boron nitride powder was determined from the measurement results obtained by the powder X-ray diffraction method. First, a recessed part of a glass cell having a recessed part having a depth of 0.2 mm was filled with the boron nitride powder, where the glass cell was attached to an X-ray diffraction device (manufactured by Rigaku Corporation, trade name: ULTIMA-IV). Then, using a powder sample molding machine (manufactured by AmenaTec Limited, trade name: PX700), the boron nitride powder was solidified at a set pressure M to adjust a measurement sample. In a case where the surface of the filling material solidified by the molding machine was not smooth, it was manually smoothed before the measurement. The measurement sample was irradiated with X-rays, and the baseline correction was carried out. Then, the peak intensity ratio between the (002) plane and the (100) plane of the boron nitride was calculated, and the orientation index [I(002)/I (100)] was determined based on this numerical value.

### (Purity)

The purity of the boron nitride powder was determined by the following method. First, the boron nitride powder was subjected to alkali decomposition with sodium hydroxide, and ammonia was distilled from the decomposition liquid by a steam distillation method and then collected in an aqueous boric acid solution. This collected liquid was titrated with a normal solution of sulfuric acid. The nitrogen atom (N) content in the boron nitride powder was calculated from the titration results. From the obtained nitrogen atom content, the boron nitride content in the boron nitride powder was determined based on the Formula (2), and the purity of the boron nitride powder was calculated. It is noted that 24.818 g/mol was used as the formula weight of boron nitride, and 14.006 g/mol was used as the atomic weight of the nitrogen atom.

$$Content of boron nitride ( BN ) in sample [ \% by mass ] = content of nitrogen atom ( N ) [ \% by mass ] \times 1.772 \qquad ( 2 )$$

### (Moisture Amount)

The moisture amount of the boron nitride powder was measured based on the Karl Fischer method in accordance with the description of JIS K0068:2001. “Test methods for moisture amount of chemical products”. Specifically, first, a predetermined amount of a measurement sample (boron nitride powder) was collected on an alumina board which had been subjected to dummy heating, and this was allowed to stand in a furnace in which the temperature was adjusted at a constant temperature of 25° C. Next, the moisture generated in a case where heating had been carried out to a measurement temperature (400° C.) was measured using nitrogen gas as a carrier gas according to a coulometric titration method. The obtained results were converted into a value per unit mass (1 g), whereby the moisture amount was determined.

### (Average Particle Diameter)

The average particle diameter of the boron nitride powder was measured using a laser diffraction scattering particle size distribution analyzer (device name: LS-13320) manufactured by Beckman Coulter Inc. in accordance with the description of ISO 13320:2009. It is noted that the boron nitride powder was not subjected to a treatment with a homogenizer. In a case of measuring the particle size distribution, water was used as a solvent for dispersing the boron nitride powder, and hexametaphosphoric acid was used as a dispersant. In this case, a numerical value of 1.33 was used as the refractive index of water, and a numerical value of 1.80 was used as the refractive index of the boron nitride powder.

### (Specific Surface Area)

The specific surface area of the boron nitride powder was calculated by applying the BET single point method using nitrogen gas, in accordance with the description of JIS Z8830:2013 “Determination of the specific surface area of powders (solids) by gas adsorption”. A specific surface area measuring device manufactured by Yuasa Ionics Co., Ltd. (device name: Quantasorb) was used as a specific surface area measuring device. It is noted that the measurement was carried out after drying and degassing the boron nitride powder at 300° C. for 15 minutes.

### (Crushing Strength)

The crushing strength of the agglomerated particles was measured in conformity with the description in JIS R1639-5:2007 “Test methods of properties of fine ceramic granules Part 5: Compressive strength of a single granule”. For the measurement, a micro-compression tester (manufactured by Shimadzu Corporation, product name “MCT-210”) was used. It is noted that 20 or more agglomerated particles were subjected to the measurement, and the value at the time when the cumulative destruction rate reached 63.2% was calculated.

### <Performance Evaluation>

### (Preparation of Sheet for Evaluation)

Each of the boron nitride powders obtained in Examples 1 to 7 and Comparative Examples 1 to 3 was used to prepare a resin composition, and the resin composition was used to prepare a sheet for evaluation. Specifically, first, a mixture of 100 parts by mass of a naphthalene-type epoxy resin (HP4032, manufactured by DIC Corporation) and 10 parts by mass of an imidazole compound (2E4 MZ-CN, manufactured by SHIKOKU KASEI HOLDINGS CORPORATION) as a curing agent was mixed with the boron nitride powder so that the boron nitride powder was 60% by volume, whereby a resin composition was obtained. Awatori Rentaro, manufactured by THINKY CORPORATION, was used for kneading with the resin. The kneading conditions were set to 1,600 rpm and 3 minutes. The obtained resin composition was applied onto a PET film to a thickness of 0.3 mm. Thereafter, heating and pressurization were carried out under conditions of a temperature of 160° C. and 50 kgf/cm² and under a relatively mild condition of 50 minutes, whereby a resin sheet (sheet for evaluation) of 0.3 mm was prepared.

### (Evaluation of Long-Term Insulating Properties)

The sheet for evaluation was subjected to a weather resistance test in which the sheet for evaluation was treated at 60° C. and 90% RH for 500 hours, and then the dielectric breakdown voltage of the sheet for evaluation after the weather resistance test was measured. The dielectric breakdown voltage was measured using a pressure testing machine (manufactured by KIKUSUI HOLDINGS CORPORATION, device name: TOS-8650) in accordance with the description in JIS C 6481-1996 “Test methods of copper-clad laminates for printed wiring boards”. The obtained dielectric breakdown voltage was subjected to relative evaluation by setting the result of Comparative Example 1, to 1.0.

### (Evaluation of Thermal Conductivity)

The thermal conductivity H (unit: W/(m K)) of the sheet for evaluation was measured. The thermal conductivity H was calculated from the values of the thermal diffusivity A (unit: m²/sec), the density B (unit: kg/m³), and the specific heat capacity C (unit: J/(kg·K)), based on a formula of H=A×B×C. The sheet for evaluation was processed into a size of a length of 10 mm, a width of 10 mm, and a thickness of 0.3 mm, and the thermal diffusivity A was measured according to the laser flash method. A xenon flash analyzer (manufactured by NETZSCH, product name: LFA447 NanoFlash) was used as a measuring device. The density B was determined using the Archimedes method. The specific heat capacity C was determined using DSC (manufactured by Rigaku Corporation, product name: ThermoPlus Evo DSC 8230). The obtained thermal conductivity was subjected to relative evaluation by setting the result of Comparative Example 1, to 1.0. It is noted that the obtained thermal conductivities were all 10 W/mK or more.

TABLE 1

| | | | Example 1 | Example 2 | Example 3 | Example 4 | Example 5 | Example 6 |
|---|---|---|---|---|---|---|---|---|
| Decarbonization- | Leakage amount | | 150 | 150 | 150 | 5.5 | 5.5 | 5.5 |
| crystallization | (×10⁻⁴ Pa · m³/sec) | | | | | | | |
| step | Nitrogen gas | | 99.95 | 99.95 | 99.95 | 99.99 | 99.99 | 99.99 |
| (conditions) | concentration (% by | | | | | | | |
| | volume) | | | | | | | |
| | Firing temperature (° C.) | | 2000 | 2000 | 2000 | 2000 | 2000 | 2000 |
| | Firing time (h) | | 5 | 5 | 5 | 5 | 5 | 5 |
| BN powder | B₂O₃ | Before test | 0.020 | 0.020 | 0.005 | 0.005 | 0.005 | 0.005 |
| (evaluation of | content | After test | 0.040 | 0.040 | 0.040 | 0.015 | 0.015 | 0.015 |

| | | | | | | | |
|---|---|---|---|---|---|---|---|
| physical | Graphitization index | 1.8 | 1.7 | 1.7 | 1.7 | 1.7 | 1.7 |
| properties) | Orientation index | 7 | 7 | 7 | 7 | 7 | 7 |
| | Purity (% by mass) | 99.5 | 99.5 | 99.8 | 99.9 | 99.9 | 99.9 |
| | Moisture amount (% | 160 | 160 | 240 | 70 | 70 | 70 |
| | by mass) | | | | | | |
| | Average particle | 40 | 40 | 40 | 40 | 80 | 15 |
| | diameter (μm) | | | | | | |
| | Specific surface area | 2.4 | 3.6 | 3.6 | 3.0 | 3.0 | 3.0 |
| | (m²/g) | | | | | | |
| | Crushing strength | 4 | 10 | 10 | 10 | 10 | 10 |
| | (MPa) | | | | | | |
| Evaluation of | Long-term insulating | 1.3 | 1.3 | 1.3 | 1.5 | 1.5 | 1.5 |
| performance | properties | | | | | | |
| | Thermal conductivity | 1.1 | 1.1 | 1.1 | 1.1 | 1.15 | 0.90 |

| | | | | Comparative | Comparative | Comparative |
|---|---|---|---|---|---|---|
| | | | Example 7 | Example 1 | Example 2 | Example 3 |
| Decarbonization- | Leakage amount | | 5.5 | — | — | — |
| crystallization | (×10⁻⁴ Pa · m³/sec) | | | | | |
| step | Nitrogen gas | | 99.99 | 99.95 | 99.95 | 99.95 |
| (conditions) | concentration (% by | | | | | |
| | volume) | | | | | |
| | Firing temperature (° C.) | | 2000 | 2000 | 2000 | 1850 |
| | Firing time (h) | | 5 | 5 | 5 | 15 |
| BN powder | B₂O₃ | Before test | 0.005 | 0.11 | 0.05 | 0.09 |
| (evaluation of | content | After test | 0.015 | 0.19 | 0.22 | 0.19 |

| | | | | | |
|---|---|---|---|---|---|
| physical | Graphitization index | 1.6 | 1.9 | 1.9 | 2.2 |
| properties) | Orientation index | 13 | 8 | 8 | 8 |
| | Purity (% by mass) | 99.9 | 99.2 | 99.2 | 99.2 |
| | Moisture amount (% | 70 | 400 | 400 | 400 |
| | by mass) | | | | |
| | Average particle | 15 | 40 | 40 | 40 |
| | diameter (μm) | | | | |
| | Specific surface area | 3.0 | 5.5 | 5.5 | 5.5 |
| | (m²/g) | | | | |
| | Crushing strength | 10 | 10 | 10 | 10 |
| | (MPa) | | | | |
| Evaluation of | Long-term insulating | 1.5 | 1.0 | 1.0 | 1.0 |
| performance | properties | | | | |
| | Thermal conductivity | 0.85 | 1.0 | 1.0 | 1.0 |

1. A boron nitride powder comprising:
agglomerated particles formed by agglomeration of primary particles of boron nitride,
wherein a graphitization index is 2.0 or less,
a boron oxide content is 0.1% by mass or less, and
a boron oxide content after a heat cycle test of a total of 1,000 cycles is 0.2% by mass or less, where one cycle is defined by the following operation (i),
(i) 10 g of the boron nitride powder is heated from 0° C. to 50° C. at a temperature rising rate of 3.0° C./min under a humidity of 80% RH, and then held for 30 minutes and cooled from 50° C. to 0° C. at a cooling rate of 1.5° C./min, followed by being held for 30 minutes.

2. The boron nitride powder according to claim 1, wherein the agglomerated particles have a crushing strength of 4 MPa or more.

3. The boron nitride powder according to claim 1, wherein the boron nitride powder has a moisture amount of 300 ppm by mass or less.

4. The boron nitride powder according to claim 1, wherein the boron nitride powder has a specific surface area of 5.0 m²/g or less.

5. The boron nitride powder according to claim 1, wherein the boron nitride powder has an average particle diameter of 10 to 90 μm.

6. The boron nitride powder according to claim 1, wherein the boron nitride powder has an orientation index of 15 or less.

7. A resin composition comprising:
a resin; and
the boron nitride powder according to claim 1.

8. A method for producing a boron nitride powder, the method comprising:
a decarbonization-crystallization step of firing and cooling a raw material mixture containing a boron carbonitride powder and a boron source to generate primary particles of boron nitride and obtaining a powder containing agglomerated particles formed by agglomeration of primary particles,
wherein in the decarbonization-crystallization step, the raw material mixture is fired and cooled in a closed space having a nitrogen gas concentration of 99.90% by volume or more and a leakage amount of 270×10⁻⁴ Pa·m³/sec or less.

9. The method for producing a boron nitride powder according to claim 8, further comprising a step of pulverizing the agglomerated particles in the powder by frictional shearing, after the decarbonization-crystallization step.

10. The method for producing a boron nitride powder according to claim 8, further comprising a step of washing the powder or a pulverized product thereof, after the decarbonization-crystallization step.

11. The method for producing a boron nitride powder according to claim 8, wherein in the decarbonization-crystallization step, the raw material mixture is fired by being heated from a temperature of 1,000° C. or lower to a holding temperature of 1,900° C. or higher at a temperature rising rate of 0.5 to 5.0° C./min and being held at the holding temperature for 2 hours or more.
